(19) United States
(12) Patent Application Publication
(10) Pub. No.: US 2005/0174922 A1
(43) Pub. Date: Aug. 11, 2005

(54) Optical head, optical recording/reproducing apparatus, and method of optical recording/reproduction utilizing the same

(75) Inventors: Giichi Shibuya, Tokyo (JP); Teiichiro Oka, Tokyo (JP); Koji Mishima, Tokyo (JP); Daisuke Yoshitoku, Tokyo (JP); Kenji Yamaga, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/047,608

(22) Filed: Feb. 2, 2005

(30) Foreign Application Priority Data
Feb. 10, 2004 (JP) 2004-033356

(51) Int. Cl. G11B 7/00

(52) U.S. Cl. 369/124.12; 369/47.17

(57) ABSTRACT

The invention relates to an optical head and an optical recording/reproducing apparatus for recording information in an optical recording medium or reproducing information recorded therein and a method of optical recording/reproduction utilizing the same. The invention provides an optical head and an optical recording/reproducing apparatus capable of reproducing an RF signal of high quality by eliminating a noise component superimposed on reflected light from a recording medium and a method of optical recording/reproduction utilizing the same. The optical head has an RF signal extraction circuit for extracting an RF signal including information recorded in a rotating recording medium. The RF signal extraction circuit has a low-pass filter for eliminating the RF signal from an electrical signal obtained by performing photoelectric conversion of laser light irradiated to and reflected by the recording medium to extract a noise signal and a differential amplifier circuit connected to the low-pass filter to perform a differential operation between the electrical signal and the noise signal.

### BACKGROUND OF THE INVENTION

1. Field of the Invention

The present invention relates to an optical head and an optical recording/reproducing apparatus for recording information in an optical recording medium or reproducing information recorded therein, and a method of optical recording/reproduction utilizing the same.

2. Description of the Related Art

An optical recording/reproducing apparatus includes an optical head which is formed along the circumferential direction of, for example, a disk-shaped optical recording medium (optical disk) and which records information in predetermined regions of a plurality of tracks formed in the radial direction of the optical recording medium or reproduces information in predetermined regions of the tracks. Optical heads include recording-only types which are used only for recording information in an optical recording medium, reproduction-only types which are used only for reproducing information, and recording/reproducing types which can be used for both of recording and reproduction. Therefore, apparatus loaded with those types of heads respectively constitute optical recording apparatus, optical reproducing apparatus and optical recording/reproducing apparatus. In this specification, the term “optical recording/reproducing apparatus” will be used as a general term that implies all of those apparatus.

An optical recording/reproduction signal obtained from a rotating optical disk includes not only a signal in a relatively high frequency band including contents information (hereinafter referred to as “an RF signal”) but also a noise component having a frequency lower than that of the RF signal, the noise originating from a fluctuating component of a fundamental rotation frequency of the optical disk and a fluctuating component that is a harmonic component equivalent to several times to several hundred times the fundamental rotation frequency. The fluctuating component is also referred to as an envelope fluctuation, and when the envelope fluctuation is great, the jitter value of an RF signal is degraded or the error rate of optical recording/reproduction signals is increased. In the related art, a high-pass filter circuit which allows only a higher frequency band of an optical recording/reproduction signal to pass has been used in order to eliminate such an envelope fluctuating component in a lower frequency band.

FIGS. 9A and 9B show examples of Bode diagrams of first-order high-pass filters, the diagrams showing frequency characteristics of three types of high-pass filters having different cut-off frequencies fc in an overlapping relationship. FIG. 9A shows gain-frequency characteristics of the high-pass filters, the abscissa axis representing frequencies (kHz) in logarithmic values, the ordinate axis representing gains in logarithmic values. FIG. 9B shows phase-frequency characteristics of the high-pass filters, the abscissa axis representing frequencies (kHz) in logarithmic values, the ordinate axis representing phases (°) in logarithmic values. In both of FIGS. 9A and 9B, the curves connecting the symbols “●” represent characteristics at a cut-off frequency fc of 100 Hz; the curves connecting the symbols “◯” represent characteristics at a cut-off frequency fc of 1 kHz; and the curves connecting the symbols “▴” represent characteristics at a cut-off frequency fc of 10 kHz. Referring to the phase characteristics of the high-pass filters, as shown in FIGS. 9A and 9B, a phase change starts at a higher frequency, the higher the cut-off frequency fc is set. For example, a phase change starts at a frequency of about 2 kHz when the cut-off frequency fc is 100 Hz and starts at a frequency of about 200 kHz when the cut-off frequency fc is 10 kHz.

A change in phase characteristics of a high-pass filter affects the jitter value of an RF signal. A jitter value is primarily used for evaluation of signal quality in an optical disk system as a whole including an optical head and an optical disk. FIG. 10 shows jitter values measured while varying the cut-off frequency fc of a high-pass filter. The signal source used for the experiment employed eye patterns for MD (Mini-Disk) format signals generated by a reference signal generator. The abscissa axis represents cut-off frequencies (kHz) in logarithmic values, and the ordinate axis represents jitter values (%). The phase of a high-pass filter is characterized in that a phase change starts at a higher frequency, the higher the cut-off frequency fc. Therefore, as shown in FIG. 10, the jitter value becomes worse, the higher the cut-off frequency fc. For example, the jitter value is a proper value of 10% when the cut-off frequency fc is about 100 Hz, but the jitter value increases when the cut-off frequency fc increases beyond 180 Hz.

Meanwhile, single-layer optical disks with a single recording layer and multi-layer optical disks with a plurality of (two or more) recording layers have been developed. A single-layer optical disk exhibits a high reflectance against light on the recording layer thereof. Therefore, when laser light irradiated to and reflected by a rotating single-layer optical disk is received by a light-receiving element and the received light is converted into an electrical signal, the electrical signal obtained will have a relatively high output amplitude. Since envelope fluctuation is not so great in comparison to the output amplitude of the RF signal, the RF signal can be satisfactorily reproduced with a first-order high-pass filter.

Multi-layer optical disks have a plurality of recording layers formed to achieve an improved recording density in order to satisfy a demand in the market for the capability of recording a greater amount of information on a single optical disk. A multi-layer optical disk has a structure in which a plurality of recording layers is formed one over another in the direction of irradiation of light toward the multi-layer optical disk. Therefore, in order to read information recorded on each of the plurality of recording layers of the multi-layer optical disk by irradiating the disk with light in one direction, the light must be reflected by each of the recording layers of the multi-layer optical disk, and an appropriate proportion of the light must be transmitted. Therefore, the quantity of light reflected by a recording layer (reproduced layer) of the multi-layer optical disk used for recording and reproduction of information is smaller than the quantity of light reflected by the recording layer of a single-layer optical disk. Thus, the output amplitude of an RF signal obtained by receiving by a light-receiving element the light reflected by the multi-layer optical disk and performing photoelectric conversion of the light is significantly smaller than the output amplitude of an RF signal obtained from the light reflected by the single-layer optical disk. For example, the reflectance of light at the recording layer of a single-layer optical disk used for reproduction only is 70% or more, and the reflectance of light at a recording layer of a multi-layer optical disk is 5% or less.

A multi-layer optical disk has a problem in that a noise component is apt to be superimposed on reflected light, in addition to the problem that the quantity of reflected light is small. Reflected light from a multi-layer optical disk includes not only reflected light from the reproduced layer but also reflected light (return light) from layers other than the reproduced layer in a quantity that cannot be ignored. Therefore, an RF signal reproduced from light reflected by a multi-layer optical disk and received by a light-receiving element includes a noise signal at a low frequency originating from inter-layer crosstalk between reflected light from the layer being reproduced and return light from recording layers other than the layer being reproduced. The quality of the reproduced RF signal is thus degraded.

The influence of the inter-layer crosstalk appears in an envelope fluctuation of the RF signal. FIGS. 11A to 11C show RF signals obtained by receiving by a light-receiving element reflected light from respective multi-layer optical disks which have different numbers of recording layers and which have no information recorded thereon and by performing photoelectric conversion of the received light. FIGS. 11A, 11B and 11C show results of measurement carried out on an optical disk having two recording layers, an optical disk having three recording layers and an optical disk having four recording layers, respectively. The abscissa axes of FIGS. 11A to 11C represent time, and the ordinate axes represent voltages. As shown in FIGS. 11A to 11C, an RF signal has an envelope fluctuation of a greater amplitude and a higher frequency, the greater the number of recording layers of the respective optical disk.

When an envelope fluctuation has a high fluctuation rate relative to the amplitude of an RF signal, the quality of the reproduced signal is degraded. In the case of a multi-layer optical disk having a small number of recording layers, since an envelope fluctuation has a low frequency, the envelope fluctuation can be eliminated from an RF signal reproduced from the disk using a high-pass filter having a low cut-off frequency fc (fc=100 Hz). In this case, since there is substantially no degradation of the jitter value (see FIG. 10), the reproduced signal is subjected to quite small degradation of quality. In the case of a multi-layer optical disk having a greater number of recording layers, since an envelope fluctuation will have a higher frequency, a high-pass filter having a higher cut-off frequency fc must be used. In this case, degradation of the jitter value occurs, and the quality of a reproduced RF signal will be degraded.

In order to cut off a signal near the cut-off frequency fc of a high-pass filter, the high-pass filter may be set at a higher order. In this case, since the high-pass filter will have steep roll-off characteristics, an attenuation band will have a great attenuation factor, which makes it possible to cut off a signal at a frequency lower than the cut-off frequency fc sufficiently. However, since a change occurs in the phase of a signal in the pass band, the jitter value of a reproduced RF signal increases. For this reason, it is difficult to set the cut-off frequency fc of a high-pass filter for optical recording and reproduction at a value that is close to the lower limit of the frequency band of an RF signal. For example, an RF signal from an MD or CD (Compact Disk) is in a frequency band of 196 kHz to 720 kHz. On the contrary, the frequency of an envelope fluctuation of an optical disk having four layers is about 1 kHz because the period of the envelope fluctuation is about 1 ms as shown in FIG. 11C. As thus described, although an envelope fluctuation can be eliminated from an RF signal using a high-pass filter of a high-order when the frequency of the envelope fluctuation (1 kHz) is close to the lower limit of the frequency band of the RF signal (196 kHz), the jitter value will increase because the phase of the RF signal will change. Therefore, a limit exists for the elimination of a noise signal frequency with a high-pass filter.

Patent Document 1 discloses an optical information recording/reproducing apparatus which eliminates a wobble signal included in an RF signal. The optical information recording/reproducing apparatus has a wobble signal elimination circuit for eliminating a wobble signal frequency or a frequency component near the same. The wobble signal elimination circuit has a low-pass filter for extracting only a wobble signal or a signal having a frequency close to or lower than that of the wobble signal. Further, the wobble signal elimination circuit has a phase circuit for changing the phase of a signal which has passed through the low-pass filter to achieve a phase match between the signal and an original reproduction signal and a differential amplifier circuit to which the signal from the phase circuit and the original reproduction signal are input. In the wobble signal elimination circuit, a wobble signal or a signal having a frequency equal to or lower than that of the wobble signal is obtained by the low-pass filter, and a phase shift equivalent to a phase change attributable to the low-pass filter is corrected by the phase circuit to restore the signal to the same phase as the original signal. Further, the differential amplifier circuit of the wobble signal elimination circuit performs a differential operation between the original reproduction signal and the wobble signal or the signal equal to or lower in frequency than the wobble signal whose phase has been restored, and the wobble signal or the noise having a frequency equal to or lower than that of wobble signal is thus eliminated. As a result, the optical information recording/reproducing apparatus can reduce degradation of a reproduction signal and reading errors attributable to such degradation.

In the case of an optical disk having two layers, when a light beam reflected by a recording surface (a first recording surface) having a beam spot formed thereon to reproduce information recorded and a light beam reflected by a recording surface (a second recording surface) different from the recording surface having a beam spot formed thereon are received by a photo detector, a reproduction signal thus obtained by the photo detector will be a reproduction signal having crosstalk attributable to noise from the second recording surface superimposed thereon, which results in a problem in that the reproduction signal has a poor signal-to-noise ratio. Patent Document 2 discloses an optical pickup apparatus which is intended for the solution of this problem. In order to perform reproduction from a multi-layer optical disk having a plurality of recording surfaces, the optical pickup apparatus has a first photo detector for receiving light reflected by a first recording surface and light reflected by a second recording surface and a second photo detector for receiving only the light reflected by the second recording surface. An electrical signal obtained by performing photoelectric conversion of the light received by the first photo detector is a signal which includes a light component reflected by the first recording surface and a light component reflected by the second recording surface. An electrical signal obtained by performing photoelectric conversion of the light received by the second photo detector is a signal which includes only the light component reflected by the second recording surface. Therefore, a reproduction signal constituted only by the light component reflected by the first recording surface is obtained by performing a differential operation between the electrical signal output by the first photo detector and the electrical signal output by the second photo detector at a differential amplifier circuit.

Patent Document 1: Japanese Patent Laid-Open No. JP-A-2000-155942

Patent Document 2: Japanese Patent Laid-Open No. JP-A-11-16200

Patent Document 1 discloses nothing about elimination of a noise component generated as a result of inter-layer crosstalk originating from return light that is specific to multi-layer optical disks. Further, since the optical pickup apparatus disclosed in Patent Document 2 must split reflected light from an optical disk into two beams of light, it is difficult to make the optical pickup apparatus compact.

Further, since the amplitudes of a high frequency component and a low frequency component of a reproduced RF signal can change, a so-called waveform equalizing process is performed before the RF signal is demodulated (binarized) to equalize the amplitude levels of the high frequency component and the low frequency component of the RF signal. Therefore, a general optical head must be provided with a waveform equalizing circuit, which results in a problem in that the cost and size of the device are increased.

### SUMMARY OF THE INVENTION

It is an object of the invention to provide an optical head and an optical recording/reproducing apparatus in which a noise component superimposed on reflected light from a recording medium can be eliminated to reproduce an RF signal with high quality and to provide a method of optical recording/reproduction utilizing the same.

The above-described object is achieved by an optical head characterized in that it has a light-receiving element for receiving laser light irradiated to and reflected by a rotating recording medium and converting an intensity of received light into an electrical signal, and an RF signal extraction circuit for extracting an RF signal including information recorded in the recording medium, having a noise signal extraction circuit for extracting a noise signal by eliminating the RF signal from the electrical signal output by the light-receiving element, and a differential amplifier circuit having a non-inverting input terminal to which the electrical signal is input and an inverting input terminal to which the noise signal is input for performing a differential operation between the electrical signal and the noise signal.

An optical head according to the above invention is characterized in that the noise signal extraction circuit is adjusted such that the RF signal is output by the RF signal extraction circuit after being subjected to waveform equalization.

An optical head according to the above invention is characterized in that the noise signal extraction circuit extracts a noise signal originating from inter-layer crosstalk that occurs between reflected light from a recording layer to be reproduced among a plurality of recording layers of the recording medium having a plurality of layers stacked one over another and reflected light from a recording layer other than the recording layer to be reproduced.

An optical head according to the above invention is characterized in that the noise signal extraction circuit has a low-pass filter.

An optical head according to the above invention is characterized in that the low-pass filter has a cut-off frequency lower than the frequency band of the RF signal.

An optical head according to the above invention is characterized in that the low-pass filter has a cut-off frequency varying circuit which allows the value of the cut-off frequency to be varied.

An optical head according to the above invention is characterized in that the noise signal extraction circuit has an amplifier circuit having frequency characteristics including a cut-off frequency lower than the frequency band of the RF signal.

An optical head according to the above invention is characterized in that it has an other light-receiving element for receiving the reflected light and converting the received light into an electrical signal, wherein the electrical signal from the other light-receiving element is input to the noise signal extraction circuit or the non-inverting input terminal of the differential amplifier circuit instead of the electrical signal from the one light-receiving element.

The above-described object is achieved by an optical recording/reproducing apparatus characterized in that it has an optical head according to any of the optical heads.

Further, the above-described object is achieved by a method of optical recording/reproduction, characterized in that it has the steps of receiving laser light irradiated to and reflected by a rotating recording medium and converting it into an electrical signal, extracting a noise signal by eliminating an RF signal including information recorded in the recording medium from the electrical signal; and extracting the RF signal by performing a differential operation between the electrical signal and the noise signal.

A method of optical recording/reproduction according to the above invention is characterized in that the RF signal extracted by the differential operation has been subjected to waveform equalization.

A method of optical recording/reproduction according to the above invention is characterized in that the noise signal originates from inter-layer crosstalk that occurs between reflected light from a recording layer to be reproduced among a plurality of recording layers formed one over another in the recording medium and reflected light from a recording layer other than the recording layer to be reproduced.

A method of optical recording/reproduction according to the above invention is characterized in that the noise signal is extracted by passing the electrical signal through a low-pass filter.

A method of optical recording/reproduction according to the above invention is characterized in that the noise signal is extracted by an amplifier circuit having frequency characteristics including a cut-off frequency lower than a lower limit of the frequency band of the RF signal.

The invention makes it possible to provide an optical head and an optical recording/reproducing apparatus capable of reproducing an RF signal of high quality by eliminating a noise component superimposed on reflected light from a recording medium. dr

### BRIEF DESCRIPTION OF THE DRAWINGS

FIG. 1 shows a schematic configuration of an optical head 1 according to a first embodiment of the invention;

FIG. 2 shows a circuit configuration of an RF signal extraction circuit 27 used in the optical head 1 according to the first embodiment of the invention;

FIGS. 3A and 3B shows examples of Bode diagrams of a low-pass filter 29 of the RF signal extraction circuit 27 used in the optical head 1 according to the first embodiment of the invention;

FIG. 4 shows jitter values of an RF signal relative to a cut-off frequency fc of the low-pass filter 29 of the RF signal extraction circuit 27 used in the optical head 1 according to the first embodiment of the invention;

FIGS. 5A and 5B show eye patterns of CD format signals reproduced by the RF signal extraction circuit 27 used in the optical head 1 according to the first embodiment of the invention;

FIG. 6 shows a schematic configuration of an optical recording/reproducing apparatus 50 according to the first embodiment of the invention;

FIG. 7 shows a circuit configuration of an RF signal extraction circuit 27 of a modification of the optical head 1 according to the first embodiment of the invention;

FIGS. 8A to 8C show a circuit configuration of an RF signal extraction circuit 85 used in an optical head 1 according to a second embodiment of the invention;

FIGS. 9A and 9B show examples of Bode diagrams of high-pass filters according to the related art;

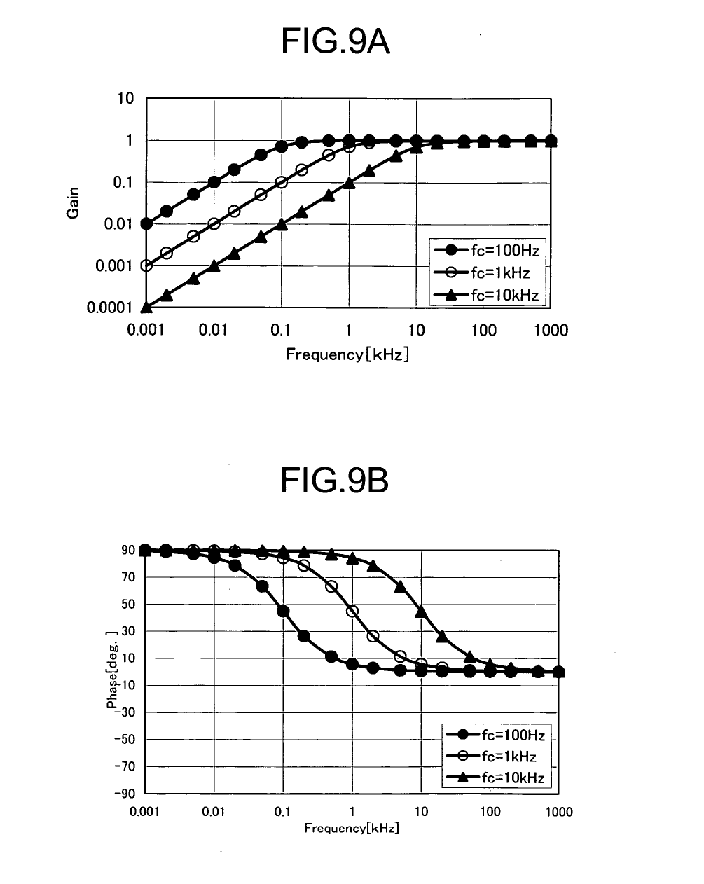

FIG. 10 shows jitter values relative to cut-off frequencies of a high-pass filter according to the related art; and

FIGS. 11A to 11C show RF signals reproduced from light reflected by optical disks having different numbers of recording layers.

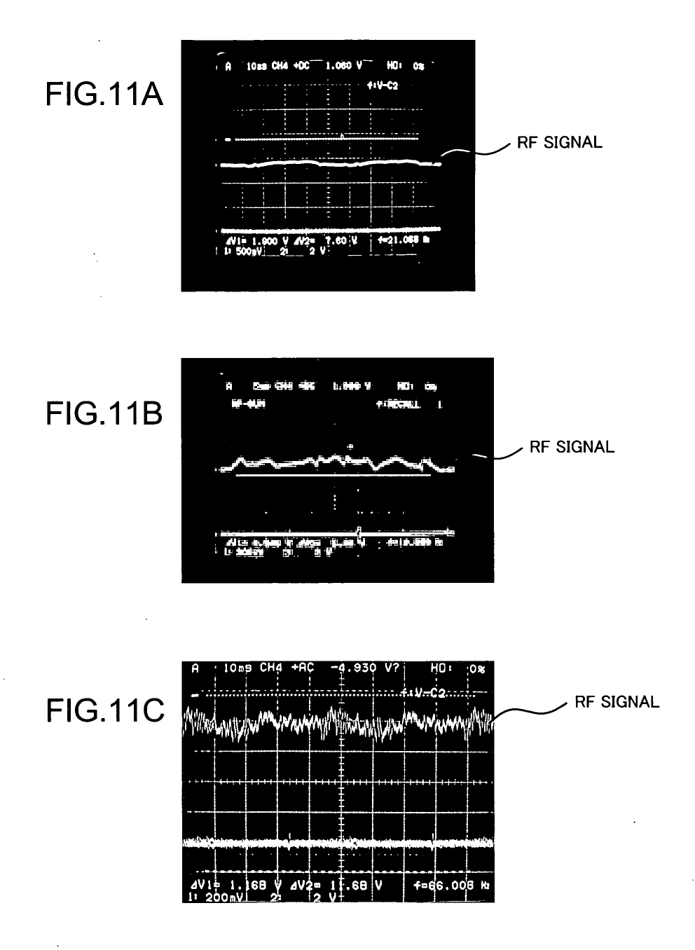

### DESCRIPTION OF THE PREFERRED EMBODIMENTS

[First Embodiment]

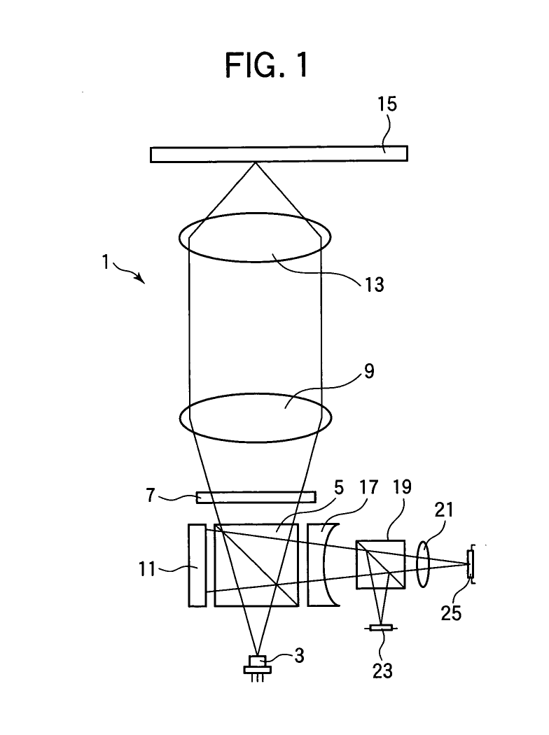

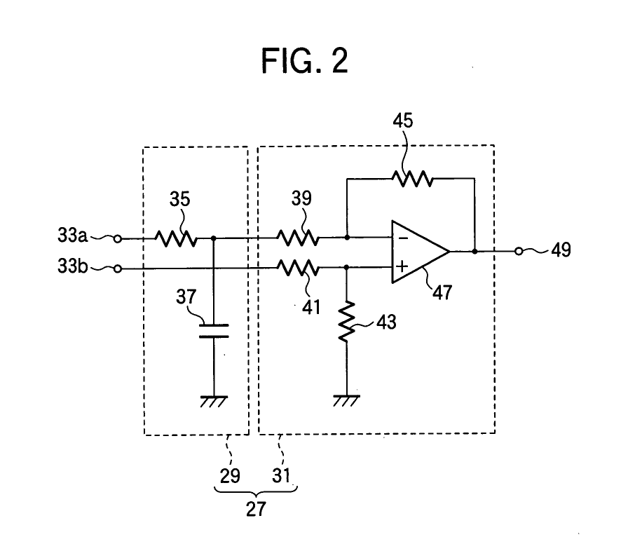

A description will now be made with reference to FIGS. 1 to 7 on an optical head, an optical recording/reproducing apparatus and a method of optical recording/reproduction utilizing the same according to a first embodiment of the invention. First, a schematic configuration of the optical head of the present embodiment will be described with reference to FIGS. 1 and 2. An optical head 1 has a laser diode 3 as a laser light-emitting element which emits laser beams. The laser diode 3 can emit laser beams having different optical intensities for recording and reproduction, respectively, based on control voltages from a controller (not shown in FIG. 1).

A polarization beam splitter 5 is provided in a predetermined position on a light-emitting side of the laser diode 3. A quarter-wave plate 7, a collimator lens 9 and an objective lens 13 are provided in a row in the order listed on a light-transmitting side of the polarization beam splitter 5 when viewed from the laser diode 3. The collimator lens 9 is provided to convert a divergent pencil of rays from the laser diode 3 into a parallel pencil of rays which is then guided to the objected lens 13 and to convert a parallel pencil of rays from the objective lens 13 into convergent pencils of rays which are then guided to light-receiving elements 23 and 25. The objective lens 13 is provided to form a reading spot by focusing a parallel pencil of rays from the collimator lens 9 on an information recording surface of a multi-layer optical disk (recording medium) 15 having a plurality of recording layers and to convert reflected light from the optical disk 15 into a parallel pencil of rays which is then guided to the collimator lens 9.

A sensor lens 17 and a beam splitter 19 are provided in the order listed on a light-reflecting side of the polarization beam splitter 5 when viewed from the quarter-wave plate 7. The light-receiving element 23 which receives reflected light from the optical disk 15 is provided on a light-reflecting side of the beam splitter 19 when viewed from the sensor lens 17. The light-receiving element 25 which receives reflected light from the optical disk 15 through a cylindrical lens 21 is provided on a light-transmitting side of the beam splitter 19 when viewed from the sensor lens 17. A power-monitoring photodiode 11 for measuring the optical intensity of laser light emitted by the laser diode 3 is provided on a light-reflecting side of the polarization beam splitter 5 when viewed from the laser diode 3.

The sensor lens 17 serves as a reflected light focusing position adjusting unit for optically adjusting a focusing position of a light beam reflected by the optical disk 15. The sensor lens 17 also generates astigmatism in reflected light from the optical disk 15 and forms enlarged images of the reflected light at a predetermined optical magnification on light-receiving portions, which are not shown, of the light-receiving elements 23 and 25. An electrical signal obtained as a result of photoelectric conversion at the light-receiving element 23 is input to an RF signal extraction circuit 27 (see FIG. 2), and the RF signal extraction circuit 27 reproduces an RF signal from the electrical signal. An electrical signal obtained as a result of photoelectric conversion at the light-receiving element 25 is used for detection of a focusing error and a tracking error.

FIG. 2 shows the RF signal extraction circuit 27 which extracts an RF signal including information recorded on the optical disk 15 from the electrical signal output by the light-receiving element 23. The RF signal extraction circuit 27 has a low-pass filter 29 which constitute a noise signal extraction circuit and a differential amplifier circuit 31. The low-pass filter 29 has a resistor 35 and a capacitor 37 which determine a cut-off frequency fc. The cut-off frequency fc is given by fc=1/(2πRC) where R represents the resistance of the resistor 35 and C represents the capacity of the capacitor 37. One terminal of the resistor 35 is connected to the light-receiving element 23 (see FIG. 1) through an input terminal 33a, and another terminal of the resistor 35 is connected to one electrode of the capacitor 37. Another electrode of the capacitor 37 is connected to a reference potential (ground). Resistors 35, 39, 41, 43 and 45 have the same value of resistance. Obviously, the resistors may alternatively be set at predetermined respective values of resistance to set the amplification factor of an operational amplifier 47 and the cut-off frequency fc of the low-pass filter 29 at predetermined values.

The differential amplifier circuit 31 includes the operational amplifier 47 and the resistors 39, 41, 43 and 45 which are used to protect inputs of the operational amplifier 47 and to determine the amplification factor of the same. One terminal of the resistor 39 is connected to the other terminal of the resistor 35, and another terminal of the resistor 39 is connected to an inverting input terminal (−) of the operational amplifier 47. One terminal of the resistor 41 is connected to the light-receiving element 23 through an input terminal 33b, and another terminal of the resistor 41 is connected to a non-inverting input terminal (+) of the operational amplifier 47. One terminal of the resistor 45 is connected to an output terminal 49 of the operational amplifier 47, and another terminal of the resistor 45 is connected to the inverting input terminal (−) of the operational amplifier 47. One terminal of the resistor 43 is connected to the non-inverting input terminal (+) of the operational amplifier 47, and another terminal of the resistor 43 is connected to the ground.

Next, an operation of the optical head 1 will be described with reference to FIG. 1. Divergent laser light emitted by the laser diode 3 impinges upon the polarization beam splitter 5. A linearly polarized light component in a predetermined polarizing direction is transmitted by the polarization beam splitter 5 to impinge upon the quarter-wave plate 7. On the other hand, a linearly polarized light component orthogonal to the above polarizing direction is reflected to impinge upon the power monitoring photodiode 11 which measures the intensity of the laser light.

The linearly polarized light which has entered the quarter-wave plate 7 is transmitted by the quarter-wave plate 7 to be converted into circularly polarized light. The circularly polarized light is converted by the collimator lens 9 into parallel light which is then transmitted by the collimator lens 9 and converged by the objective lens 13 to impinge upon a predetermined recording layer of the optical disk 15. Circularly polarized light reflected by the recording layer of the optical disk 15 is converted by the objective lens 13 into parallel light which is then transmitted by the collimator lens 9 to impinge upon the quarter-wave plate 7. The circularly polarized light is transmitted by the quarter-wave plate 7 and is thereby converted into linearly polarized light whose polarizing direction is at 90 degrees of rotation from that of the initial linearly polarized light, the linearly polarized light impinging upon the polarization beam splitter 5. The linearly polarized light is reflected by the polarization beam splitter 5 to impinge upon the sensor lens 17.

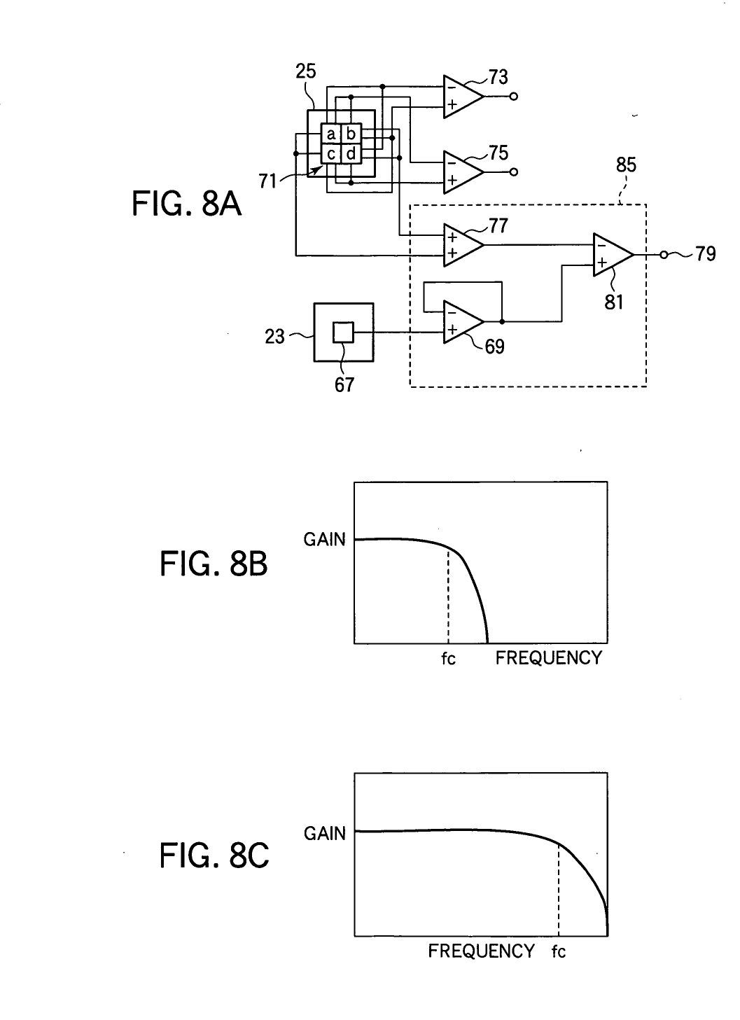

After being transmitted by the sensor lens 17, the light impinges upon the beam splitter 19. Substantially one half of the incident light is reflected by the beam splitter 19 to impinge upon the light-receiving element 23. The rest of the incident-light is transmitted by the beam splitter 19 to impinge upon the cylindrical lens 21. The light which has entered the cylindrical lens 21 is focused on the light-receiving element 25. The light-receiving element 25 has four light-receiving element patterns a, b, c and d which are four square divisions of a light-receiving portion 71 (see FIG. 8A). The shape of a beam spot on the light-receiving element patterns a, b, c and d changes in response to a change in the distance between the objective lens 13 and the optical disk 15 or a movement of the beam spot in the radial direction of the optical disk 15. Such changes are detected by the light-receiving element 25, and a focus error signal having an S-shaped characteristic curve that is symmetric about a reference position is obtained from the detection signal.

A method of optical recording/reproduction utilizing the RF signal extraction circuit 27 will now be described with reference to FIG. 2. Light received by the light-receiving element 23 includes not only reflected light from a recording layer (or a layer to be reproduced) of the optical disk 15 which is being irradiated with laser light to record or reproduce information but also light including reflected light (return light) from a layer other than the reproduced layer and a noise component generated by birefringence of the optical disk 15 and various other factors. Therefore, an electrical signal obtained as a result of photoelectric conversion of the light received by the light-receiving element 23 includes an RF signal and a noise signal originating from inter-layer crosstalk between the reflected light from the layer being reproduced and the return light from the recording layer other than the layer to be reproduced. The influence of the inter-layer crosstalk appears in an envelope fluctuation of the RF signal. The electrical signal output by the light-receiving element 23 is input to the RF signal extraction circuit 27 through the input terminals 33a and 33b. When the electrical signal input to the input terminal 33a is input to the low-pass filter 29, the RF signal that is a high frequency component in the frequency band of the electrical signal is eliminated, and only the noise signal which is a low frequency component is output by the low-pass filter 29. The noise signal extracted by the low-pass filter 29 is input to the inverting input terminal (−) of the differential amplifier circuit 31 through the resistor 39. The electrical signal input to the input terminal 33b is directly input to the non-inverting input terminal (+) of the differential amplifier circuit 31 through the resistor 41. The differential amplifier circuit 31 extracts only the RF signal by performing a differential operation between the electrical signal and the noise signal, and the differential amplifier circuit 31 is output the RF signal from the output terminal 49.

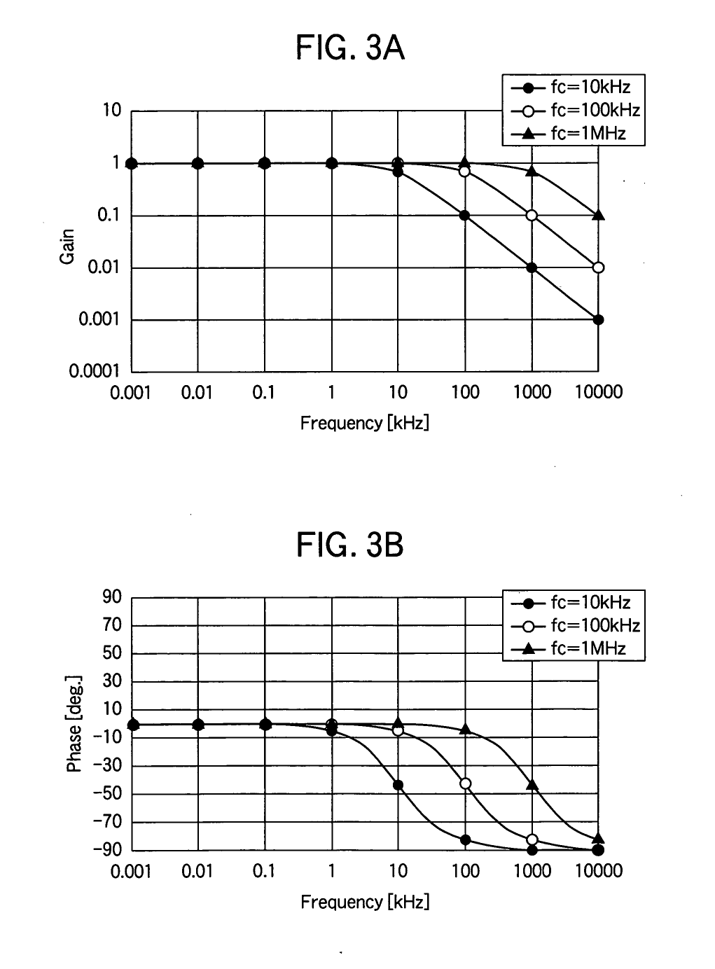

FIGS. 3A and 3B show examples of Bode diagrams of the first-order low-pass filter, the diagrams showing frequency characteristics of three types measured with the cut-off frequency fc varied in an overlapping relationship. FIG. 3A shows gain-frequency characteristics of the low-pass filter 29, the abscissa axis representing frequencies (kHz) in logarithmic values, the ordinate axis representing gains in logarithmic values. FIG. 3B shows phase-frequency characteristics of the low-pass filter 29, the abscissa axis representing frequencies (kHz) in logarithmic values, the ordinate axis representing phases (°). In both of FIGS. 3A and 3B, the curves connecting the symbols “●” represent characteristics at a cut-off frequency fc of 10 kHz; the curves connecting the symbols “◯” represent characteristics at a cut-off frequency fc of 100 kHz; and the curves connecting the symbols “▴” represent characteristics at a cut-off frequency fc of 1 MHz. As apparent from FIG. 3B, no phase change occurs in a signal at a frequency lower than the cut-off frequency fc even if it is passed through the low-pass filter 29. Therefore, when the cut-off frequency fc of the low-pass filter 29 is set at a value higher than the frequency of a noise signal, the low-pass filter 29 can extract the noise signal efficiently. The phase of a signal having a frequency higher than the cut-off frequency fc changes at the low-pass filter 29. However, since an RF signal which has a frequency higher than that of a noise signal is eliminated by the low-pass filter 29, the extraction of a low-frequency noise signal will not be affected by a phase change or attenuation of the RF signal.

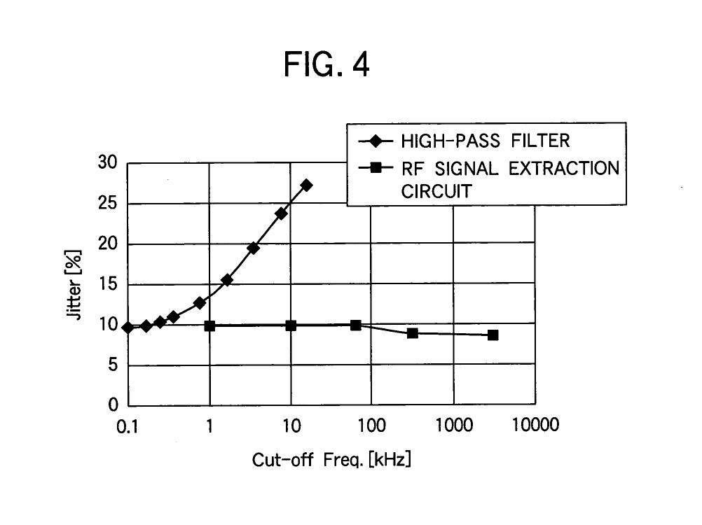

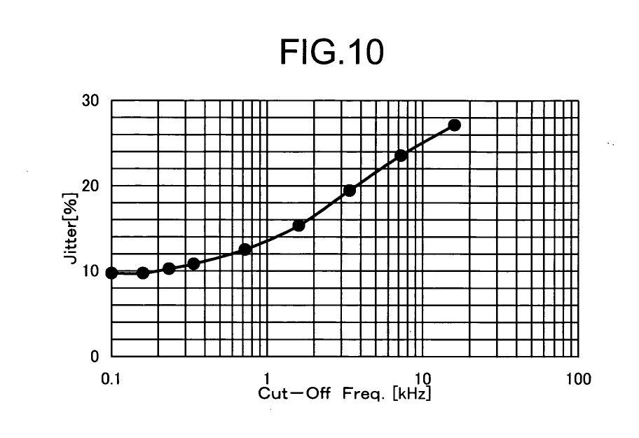

FIG. 4 shows jitter values of an RF signal measured while varying the cut-off frequency fc of the low-pass filter 29. The signal source used for the experiment employed eye patterns in the MD (Mini-Disk) format generated by a reference signal generator. The abscissa axis represents cut-off frequencies (kHz) in logarithmic values, and the ordinate axis represents jitter values (%). The curve connecting the symbols “▪” in the figure represents jitter value of an RF signal reproduced by the RF signal extraction circuit 27, and the curve connecting the symbols “♦” in the figure represents the jitter value of an RF signal reproduced by the high-pass filter shown in FIG. 10. As shown in FIG. 4, the jitter value of the RF signal reproduced by the RF signal extraction circuit 27 is not degraded even when the cut-off frequency fc is varied, and the jitter value is maintained substantially at 10%. The cut-off frequency fc of the RF signal extraction circuit 27 can therefore be set to have a wide range. As a result, even when the frequency of a noise signal (the frequency of an envelope fluctuation) originating from inter-layer crosstalk that occurs between light reflected by a reproduced layer of the optical disk 15 and return light from a recording layer other than the reproduced layer approaches the frequency of an RF signal, the RF signal extraction circuit 27 can extract the noise signal efficiently. Thus, the RF signal extraction circuit 27 can reproduce the RF signal with high quality.

The low-pass filter 29 has predetermined roll-off characteristics due to which a signal component is more apt to be passed, the closer the frequency of the signal component to the cut-off frequency fc. For example, when the cut-off frequency fc of the low-pass filter 29 is set at a value slightly smaller than the lower limit of the frequency band of the RF signal, a frequency component in the RF signal frequency band is more apt to be passed by the low-pass filter 29, the closer the frequency component to the cut-off frequency cf. Therefore, a signal which has been input from the input terminal 33a and passed by the low-pass filter 29 includes a noise signal and an RF signal component which have not been cut off by the low-pass filter 29. A frequency component in the RF signal frequency band is more apt to be attenuated by the low-pass filter 29, the higher the frequency component. Therefore, when an electrical signal passed by the low-pass liter 29 and an electrical signal input from the input terminal 33b are subjected to a differential operation at the differential amplifier circuit 31, a resultant signal output by the RF signal extraction circuit 27 will be a signal in which RF signal component in a low frequency band near the cut-off frequency fc is appropriately attenuated while an RF signal component in a higher frequency band is maintained.

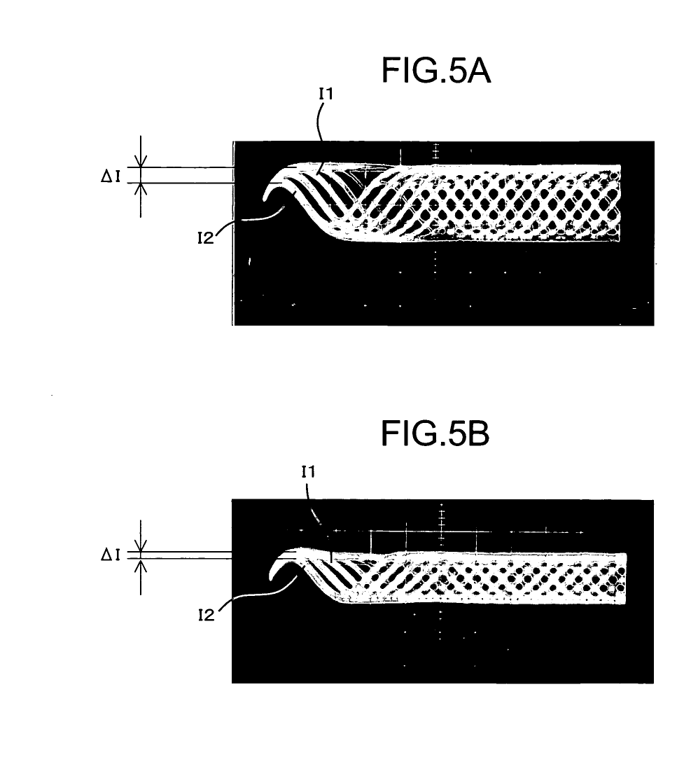

FIGS. 5A and 5B show eye patterns of CD format signals reproduced by the RF signal extraction circuit 27. FIG. 5A shows an eye pattern of a CD format signal input to the RF signal extraction circuit 27, and FIG. 5B shows an eye pattern of a CD format signal reproduced by the RF signal extraction circuit 27. In those figures, the abscissa axes represent time, and the ordinate axes represent amplitudes. I1 represents a component having a maximum amplitude (low frequency component) of an RF signal, and I2 represents a component having a minimum amplitude (high frequency component) of the RF signal. The cut-off frequency fc of the low-pass filter 29 is set at about 3 MHz which is equivalent to 70% of the clock frequency.

As shown in FIGS. 5A and 5B, an amplitude difference ΔI between the components I1 and I2 of the signal reproduced by the RF signal extraction circuit 27 is smaller than that of the signal input to the RF signal extraction circuit 27. At the low-pass filter 29, a component of an RF signal is less apt to be attenuated, the lower the frequency of the component. The component is more apt to be attenuated, the higher the frequency of the same. Therefore, when a differential operation is performed between the signal which has passed the low-pass filter 29 and the signal which has not passed the low-pass filter 29, the amplitude of the component I1 having a low frequency is attenuated, and substantially no attenuation occurs in the amplitude of the component I2 having a high frequency. As a result, the amplitude of the component I1 approaches the amplitude of the component I2, and the signal reproduced by the RF signal extraction circuit 27 has a small amplitude difference ΔI. As will be apparent from above, the RF signal extraction circuit 27 exhibits the function of equalizing waveforms (functions as an equalizer). Thanks to the waveform equalizing function, the RF signal extraction circuit 27 can maintain the jitter value of the RF signal substantially constant.

As described above, the optical head 1 of the present embodiment has the RF signal extraction circuit 27 including the low-pass filter 29 and the differential amplifier circuit 31. The RF signal extraction circuit 27 can efficiently extract a noise signal using the low-pass filter 29 from an electrical signal obtained by performing photoelectrical conversion of reflected light from the optical disk 15 with the light-receiving element 23. The RF signal extraction circuit 27 can reproduce an RF signal with high quality by performing a differential operation between the noise signal and the electrical signal at the differential amplifier circuit 31. Further, since the RF signal extraction circuit 27 can function similarly to a waveform equalizing circuit, the output terminal 49 of the RF signal extraction circuit 27 can be directly connected to a demodulation circuit (binarizing circuit) which is not shown. It is therefore possible to provide the optical head 1 in a small size at a low cost.

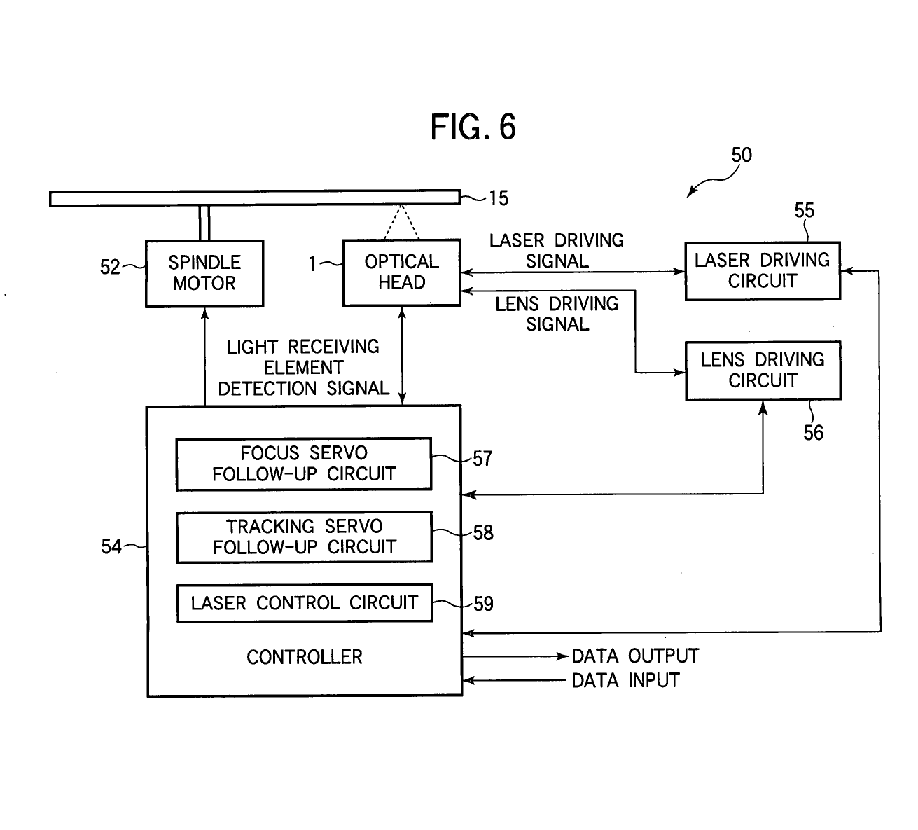

FIG. 6 shows a schematic configuration of an optical recording/reproducing apparatus 50 mounting an optical head 1 according to the present embodiment. As shown in FIG. 6, the optical recording/reproducing apparatus 50 has a spindle motor 52 for rotating an optical disk 15, the optical head 1 for irradiating the optical disk 15 with laser beams and receiving reflected light from the same, a controller 54 for controlling operations of the spindle motor 52 and the optical head 1, a laser driving circuit 55 for supplying laser driving signals to the optical head 1 and a lens driving circuit 56 for supplying lens driving signals to the optical head 1.

The controller 54 includes a focus servo follow-up circuit 57, a tracking servo follow-up circuit 58 and a laser control circuit 59. When the focus servo follow-up circuit 57 is activated, an information recording surface of the optical disk 15 is focused when the disk is rotating. When the tracking servo follow-up circuit 58 is activated, a laser beam spot is made to automatically follow up an eccentric signal track of the optical disk 15. The focus servo follow-up circuit 57 and the tracking servo follow-up circuit 58 have automatic gain control functions for automatically adjusting a focus gain and a tracking gain, respectively. The laser control circuit 59 is a circuit for generating the laser driving signals to be supplied by the laser driving circuit 55, and the circuit generates proper laser driving signals based on recording condition setting information that is recorded on the optical disk 15.

It is not essential that the focus servo follow-up circuit 57, the tracking servo follow-up circuit 58 and the laser control circuit 59 are circuits incorporated in the controller 54, and they may be components separate from the controller 54. Further, it is not essential that the circuits are physical circuits, and they may be implemented as software executed in the controller 54.

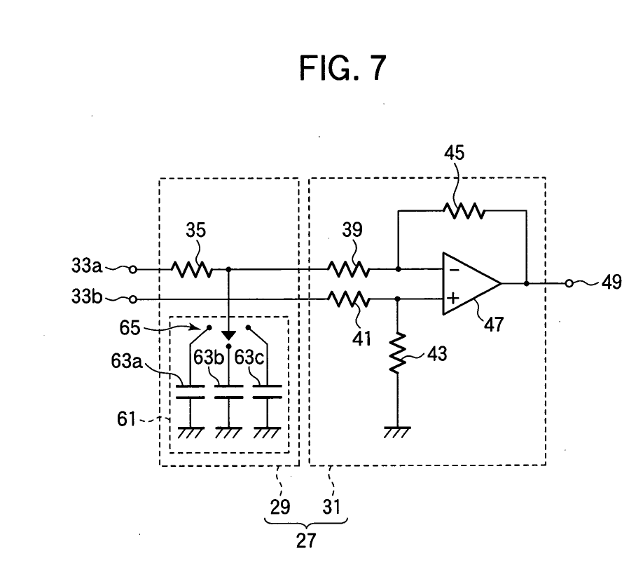

A modification of the above-described embodiment will now be described with reference to FIG. 7. FIG. 7 shows a circuit configuration of an RF signal extraction circuit 27 according to the present modification. In the above-described embodiment, the cut-off frequency fc of the low-pass filter 29 is fixed. On the contrary, the present modification is characterized in that a low-pass filter 29 is provided with a cut-off frequency varying circuit 61 to allow a cut-off frequency fc of the low-pass filter 29 to be varied.

The cut-off frequency varying circuit 61 has a switch 65 which is connected to the other terminal of the resistor 35 as described above. The switch 65 has three switching terminals. The first switching terminal is connected to one electrode of a capacitor 63a. The second switching terminal is connected to one electrode of a capacitor 63b. The third switching terminal is connected to one electrode of a capacitor 63c. Other electrodes of the capacitors 63a, 63b and 63c are connected to the ground.

The frequency band of an envelope fluctuation of an RF signal or a signal reproduced from the same varies depending on the speed of rotation of the optical disk 15 and the relative speed of the optical head 1 and the optical disk 15 even when the recording density of the optical disk 15 remains constant. Under the circumstance, the cut-off frequency fc of the low-pass filter 29 can be set at a value that is optimal for the environment of use of the device by switching the switch 65 based on the environment, e.g., the type of the optical disk 15 (MD, Cd or the like) and the speed of rotation of the same. It is not essential that the cut-off frequency varying circuit 61 has three switching positions, and it may alternatively have two positions or four or more positions. Further, a plurality of resistors having different values of resistance may be provided in parallel with the resistor 35, and the resistors may be switched to change the cut-off frequency fc.

As thus described, in the present modification, an envelope fluctuation attributable to factors such as the speed of rotation of the optical disk 15 can be eliminated. As a result, degradation of the jitter value of an RF signal can be suppressed, and the RF signal extraction circuit 27 can reproduce an RF signal with higher quality.

[Second Embodiment]

A description will now be made with reference to FIGS. 8A to 8C on an optical head, an optical recording/reproducing apparatus and a method of optical recording/reproduction utilizing the same according to a second embodiment of the invention. The description of the optical head and the optical recording/reproducing apparatus of the present embodiment will omit their commonalities to the optical head 1 and the optical recording/reproducing apparatus 50 of the first embodiment, and the description will address differences only. FIGS. 8A to 8C show a circuit configuration and gain-frequency characteristics of an RF signal extraction circuit 85 according to the present modification. FIG. 8A shows a circuit configuration of the RF signal extraction circuit 85. FIG. 8B shows gain-frequency characteristics of an operational amplifier (amplifier circuit) 77 for extracting a noise signal. FIG. 8C shows gain-frequency characteristics of an operational amplifier (amplifier circuit) 69 to which an electrical signal obtained by photoelectrical conversion at a light-receiving element 23 is input. In FIGS. 8B and 8C, the abscissa axes represent frequencies, and the ordinate axes represent gains.

As shown in FIG. 8A, the RF signal extraction circuit 85 has the operational amplifier 77 for extracting a noise signal, the operational amplifier 69 which outputs a signal output by the light-receiving element 23 as it is, and an operational amplifier (differential amplifier circuit) 81 for performing a differential operation between signals output by the operational amplifiers 69 and 77, respectively. A non-inverting input terminal (+) of the operational amplifier 77 is connected to a light-receiving portion 71 of a light-receiving element 25, and an output terminal of the operational amplifier 77 is connected to an inverting input terminal (−) of the operational amplifier 81. A non-inverting input terminal (+) of the operational amplifier 69 is connected to a light-receiving portion 67 of the light-receiving element 23. An output terminal of the operational amplifier 69 is connected to an inverting input terminal (−) of the operational amplifier 69 and a non-inverting input terminal (+) of the operational amplifier 81.

The light-receiving element 25 has four light-receiving element patterns a, b, c and d which are four square divisions of a light-receiving portion 71. Operational amplifiers 73 and 75 connected to the light-receiving element patterns a, b, c and d are used for detection of a focus error and a tracking error, respectively. As described above in relation to the first embodiment, the position and shape of a beam spot on the light-receiving element patterns a, b, c and d changes in response to a change in the distance between an objective lens 13 and an optical disk 15 (see FIG. 1) or a movement of the beam spot in the radial direction of the optical disk 15. A focus error detection output signal is calculated by performing a differential operation between the sum of outputs from the light-receiving element patterns a and d and the sum of outputs from the light-receiving element patterns b and c. A tracking error detection output signal is calculated by performing a differential operation between the sum of outputs from the light-receiving element patterns a and b and the sum of outputs from the light-receiving element patterns c and d.

An electrical signal output from the light-receiving element patterns a, b, c and d includes an RF signal and a noise signal originating from inter-layer crosstalk that occurs between light reflected by the reproduced layer of the optical disk 15 and return light from a recording layer other than the reproduced layer. When the electrical signal is input to the operational amplifier 77 which has frequency characteristics including a cut-off frequency fc lower than the frequency band of the RF signal as shown in FIG. 8B, the operational amplifier 77 extracts the noise signal to provide the same function as the low-pass filter 29 in the first embodiment. An electrical signal which has been received and photo-electrically converted by the light-receiving element 23 also includes an RF signal and a noise signal. Therefore, when the electrical signal is input to the operational amplifier 69 which has frequency characteristics including a cu-off frequency fc higher then the frequency band of the RF signal as shown in FIG. 8C, the operational amplifier 69 outputs an output signal including the noise signal and the RF signal. Then, a differential operation is performed between the signals by inputting the output signal from the operational amplifier 69 to the non-inverting input terminal (+) of the operational amplifier 81 and inputting the output signal from the operational amplifier 77 to the inverting input terminal (−) of the operational amplifier 81, and an RF signal thus reproduced is output at an output terminal 79 of the operational amplifier 81.

As thus described, the RF signal extraction circuit 85 of the present embodiment can extract the noise signal with the operational amplifier 77. The RF signal extraction circuit 85 can reproduce a high quality RF signal having a small envelope fluctuation by performing a differential operation between the electrical signal including the RF signal and the noise signal and the noise signal extracted by the operational amplifier 77. Further, since the RF signal extraction circuit 85 can reproduce the RF signal of high quality only by performing a differential operation between the noise signal and the electrical signal, no complicated signal processing circuit is required, which makes it possible to reduce the burden of designing and to provide an optical head 1 at a low cost.

The invention is not limited to the above-described embodiments and may be modified in various ways.

While the RF signal extraction circuit 27 in the above-described embodiment is equipped with the optical head 1, this is not limiting the invention. For example, the circuit maybe equipped with an optical recording/reproducing apparatus separately from the optical head 1.

While an electrical signal obtained by photoelectric conversion at the light-receiving element 23 is input to the input terminals 33a and 33b in the first embodiment described above, this is not limiting the invention. For example, an electrical signal obtained by photoelectric conversion at the light-receiving element 25 may be input to the input terminal 33a, and an electrical signal obtained by photoelectric conversion at the light-receiving element 23 may be input to the input terminal 33b. Alternatively, an electrical signal obtained by photoelectric conversion at the light-receiving element 23 may be input to the input terminal 33a, and an electrical signal obtained by photoelectric conversion at the light-receiving element 25 may be input to the input terminal 33b.

While the low-pass filter 29 used in the RF signal extraction circuit 27 in the first embodiment is a passive type low-pass filter, this is not limiting the invention. For example, the low-pass filter used in the RF signal extraction circuit 27 may be an active type.

While electrical signals obtained by photoelectric conversion at the different light-receiving elements 23 and 25 are input to the operational amplifiers 69 and 77, respectively, in the second embodiment, this is not limiting the invention. For example, an electrical signal obtained by photoelectric conversion at the same light-receiving element may be input to the operational amplifiers 69 and 77.

While an electrical signal obtained by photoelectric conversion at the light-receiving element 23 is input to the operational amplifier 69 and an electrical signal obtained by photoelectric conversion at the light-receiving element 25 is input to operational amplifier 77 in the second embodiment, this is not limiting the invention. For example, an electrical signal obtained by photoelectric conversion at the light-receiving element 23 may be input to the operational amplifier 77, and an electrical signal obtained by photoelectric conversion at the light-receiving element 25 may be input to the operational amplifier 69.

While an electrical signal obtained by photoelectric conversion at the light-receiving element 23 is input to the operational amplifier 69 in the second embodiment, this is not limiting the invention. For example, an electrical signal obtained by photoelectric conversion at the light-receiving element 23 may be input to the non-inverting input terminal (+) of the operational amplifier 81 without using the operational amplifier 69.

The various modified optical heads and optical recording/reproducing apparatus described above can reproduce an RF signal of high quality.

1. An optical head comprising:
a light-receiving element for receiving laser light irradiated to and reflected by a rotating recording medium and converting an intensity of received light into an electrical signal; and
an RF signal extraction circuit for extracting an RF signal including information recorded in the recording medium, having a noise signal extraction circuit for extracting a noise signal by eliminating the RF signal from the electrical signal output by the light-receiving element, and a differential amplifier circuit having a non-inverting input terminal to which the electrical signal is input and an inverting input terminal to which the noise signal is input for performing a differential operation between the electrical signal and the noise signal.

2. An optical head according to claim 1, wherein the noise signal extraction circuit is adjusted such that the RF signal is output by the RF signal extraction circuit after being subjected to waveform equalization.

3. An optical head according to claim 1, wherein the noise signal extraction circuit extracts a noise signal originating from inter-layer crosstalk that occurs between reflected light from a recording layer to be reproduced among a plurality of recording layers of the recording medium having a plurality of layers stacked one over another and reflected light from a recording layer other than the recording layer to be reproduced.

4. An optical head according to claim 1, wherein the noise signal extraction circuit has a low-pass filter.

5. An optical head according to claim 4, wherein the low-pass filter has a cut-off frequency lower than the frequency band of the RF signal.

6. An optical head according to claim 5, wherein the low-pass filter has a cut-off frequency varying circuit which allows the value of the cut-off frequency to be varied.

7. An optical head according to claim 1, wherein the noise signal extraction circuit has an amplifier circuit having frequency characteristics including a cut-off frequency lower than the frequency band of the RF signal.

8. An optical head according to claim 1, further comprising an other light-receiving element for receiving the reflected light and converting the received light into an electrical signal, wherein the electrical signal from the other light-receiving element is input to the noise signal extraction circuit or the non-inverting input terminal of the differential amplifier circuit instead of the electrical signal from the one light-receiving element.

9. An optical recording/reproducing apparatus comprising an optical head according to claim 1.

10. A method of optical recording/reproduction comprising the steps of:
receiving laser light irradiated to and reflected by a rotating recording medium and converting it into an electrical signal;
extracting a noise signal by eliminating an RF signal including information recorded in the recording medium from the electrical signal; and
extracting the RF signal by performing a differential operation between the electrical signal and the noise signal.

11. A method of optical recording/reproduction according to claim 10, wherein the RF signal extracted by the differential operation has been subjected to waveform equalization.

12. A method of optical recording/reproduction according to claim 10, wherein the noise signal originates from inter-layer crosstalk that occurs between reflected light from a recording layer to be reproduced among a plurality of recording layers formed one over another in the recording medium and reflected light from a recording layer other than the recording layer to be reproduced.

13. A method of optical recording/reproduction according to claim 10, wherein the noise signal is extracted by passing the electrical signal through a low-pass filter.

14. A method of optical recording/reproduction according to claim 10, wherein the noise signal is extracted by an amplification circuit having frequency characteristics including a cut-off frequency lower than a lower limit of the frequency band of the RF signal.
